(19) United States
(12) Patent Application Publication
(10) Pub. No.: US 2025/0298335 A1
(43) Pub. Date: Sep. 25, 2025

(54) IMAGE FORMING SYSTEM AND METHOD FOR USING PHOTOCONDUCTOR

(71) Applicant: FUJIFILM Business Innovation Corp., Tokyo (JP)

(72) Inventors: Shingo OHIRA, Kanagawa (JP); Shinya Makiura, Kanagawa (JP)

(73) Assignee: FUJIFILM Business Innovation Corp., Tokyo (JP)

(21) Appl. No.: 18/787,439

(22) Filed: Jul. 29, 2024

(30) Foreign Application Priority Data
Mar. 25, 2024 (JP) 2024-048751

(51) Int. Cl. G03G 15/01; G03G 15/00; G03G 21/00

(52) U.S. Cl. CPC G03G 15/0189; G03G 15/0121; G03G 15/5008; G03G 21/0011; G03G 21/0035; G03G 21/007; G03G 2215/00059

(57) ABSTRACT

An image forming system includes multiple photoconductors that rotate in a predetermined direction, the multiple photoconductors each having a surface on which an electrostatic latent image is formed by a difference in charging potential; multiple developing devices that are each disposed to face a corresponding one of the photoconductors, the multiple developing devices each carrying a developer containing toner of a different color, the multiple developing devices each developing the electrostatic latent image with the toner to form a toner image; multiple cleaners that are each disposed downstream from a corresponding one of the developing devices and downstream from a transfer position of the toner image in a rotation direction of a corresponding one of the photoconductors, the multiple cleaners each having a plate shape, the multiple cleaners each being in contact with the photoconductor to clean the surface of the photoconductor; and at least one processor, in which the processor is configured to, in a case where the developer in any of the developing devices is changed to a developer containing toner of a different color, rotate the photoconductor located to face the developing device in a direction opposite to the predetermined direction, and to then form a belt-shaped toner image on the surface of the photoconductor with the developing device.

### CROSS-REFERENCE TO RELATED APPLICATIONS

This application is based on and claims priority under 35 USC 119 from Japanese Patent Application No. 2024-048751 filed Mar. 25, 2024.

### BACKGROUND

### (i) Technical Field

The present disclosure relates to an image forming system and a method for using a photoconductor.

### (ii) Related Art

Japanese Unexamined Patent Application Publication No. 2004-046808 discloses a method for operating a machine, the method including preparing a replaceable subassembly separable from the machine and including a memory while storing, in the memory, a software code of an executable instruction relating to an operation of the machine, placing the replaceable subassembly in the machine, reading the memory, placing the stored software code of the executable instruction in the machine as a new software code, and operating the machine as instructed by the new software code.

Japanese Unexamined Patent Application Publication No. 2006-106692 discloses an image forming apparatus to and from which multiple cartridges are attachable and detachable. The multiple cartridges each include multiple processing members used to form images and a storage medium for storing information. The image forming apparatus includes a storage that stores multiple items of setting information for setting image forming conditions in accordance with multiple characteristics of the cartridges, and a controller that sets the image forming conditions based on information on the usage of each of the multiple cartridges and information used for selecting any of the multiple items of set information stored in the storage medium of each cartridge.

### SUMMARY

Aspects of non-limiting embodiments of the present disclosure relate to an image forming system and a method for using a photoconductor that enable continuous use of a photoconductor without involving replacement of the photoconductor, when a developer in a developing device is changed to a developer containing toner of a different color.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including multiple photoconductors that rotate in a predetermined direction, the multiple photoconductors each having a surface on which an electrostatic latent image is formed by a difference in charging potential; multiple developing devices that are each disposed to face a corresponding one of the photoconductors, the multiple developing devices each carrying a developer containing toner of a different color, the multiple developing devices each developing the electrostatic latent image with the toner to form a toner image; multiple cleaners that are each disposed downstream from a corresponding one of the developing devices and downstream from a transfer position of the toner image in a rotation direction of a corresponding one of the photoconductors, the multiple cleaners each having a plate shape, the multiple cleaners each being in contact with the photoconductor to clean the surface of the photoconductor; and at least one processor, wherein the processor is configured to, in a case where the developer in any of the developing devices is changed to a developer containing toner of a different color, rotate the photoconductor located to face the developing device in a direction opposite to the predetermined direction, and to then form a belt-shaped toner image on the surface of the photoconductor with the developing device.

### BRIEF DESCRIPTION OF THE DRAWINGS

Exemplary embodiments of the present disclosure will be described in detail based on the following figures, wherein:

FIG. 1 is a schematic diagram of a structure of an image forming system according to a first exemplary embodiment, when viewed from the front;

FIG. 2 is a schematic structure diagram of a developing device included in the image forming system according to the first exemplary embodiment;

FIG. 3 is a schematic structure diagram of a developer cartridge and a supply path included in the image forming system according to the first exemplary embodiment;

FIG. 4 is a block diagram of a hardware structure of the image forming system according to the first exemplary embodiment;

FIG. 5 is a structure diagram of an example of the image forming system according to the first exemplary embodiment, in which a developer cartridge holding a developer containing spot-color toner is exchanged with a developer cartridge holding a developer containing yellow toner;

FIG. 6A is a diagram of a state where a toner pile is that has accumulated at a contact portion between the photoconductor and the far end of a cleaning blade by rotating a photoconductor in a direction indicated by arrow A and, and FIG. 6B is a diagram of a result obtained after a toner pile is flattened by rotating the photoconductor in an opposite direction;

FIG. 7A is a diagram of a state where a toner band is formed with spot-color toner on the surface of the photoconductor, and FIG. 7B is a diagram of a state where a toner band is formed with yellow toner on the surface of the photoconductor;

FIG. 8 is a flowchart of the processing flow of the image forming system according to the first exemplary embodiment; and

FIG. 9 is a structure diagram of an example of an image forming system according to a second exemplary embodiment, where a developer cartridge holding a developer containing first spot-color toner is replaced with a developer cartridge holding a developer containing second spot-color toner.

### DETAILED DESCRIPTION

Exemplary embodiments according to the present disclosure are described below with reference to the drawings. In the following description, a direction indicated with arrow X is defined as a device width direction, and a direction indicated with arrow Y is defined as a device height direction. In addition, a direction (a direction indicated by arrow Z) orthogonal to the device width direction and the device height direction is defined as a device depth direction.

### First Exemplary Embodiment

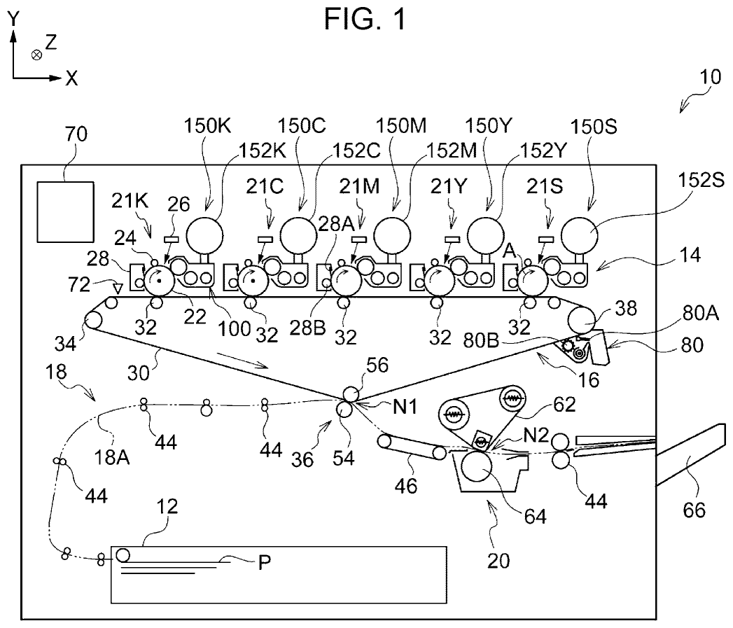

FIG. 1 illustrates an image forming system 10 according to a first exemplary embodiment. First, the image forming system 10 according to the first exemplary embodiment (refer to FIG. 1) is described. Subsequently, a developing device 100 and a developer replenishment device 150 are described.

### Entire Structure of Image Forming System

As illustrated in FIG. 1, the image forming system 10 is an electrophotographic device including a recording medium holder 12, a toner image forming portion 14, a transfer device 16, a recording medium transporting device 18, a fixing device 20, and a controller 70.

The recording medium holder 12 has a function of holding sheets P serving as an example of recording media. Although not illustrated, the recording medium holder 12 may include multiple holders to hold multiple types of sheets P.

The toner image forming portion 14 has a function of forming toner images carried on an intermediate transfer belt 30, constituting the transfer device 16, by performing a charging process, an exposure process, and a development process. The intermediate transfer belt 30 is described below. The toner image forming portion 14 includes, for example, monochrome units 21Y, 21M, 21C, 21K, and 21S that each form toner images on a corresponding one of photoconductors 22 with toner of a different color (yellow (Y), magenta (M), cyan (C), black (K), or a spot color (S)). The toner image forming portion 14 forms, for example, toner images of multiple colors in accordance with image data. Toner of yellow (Y), magenta (M), cyan (C), and black (K) is an example of normal-color toner. Toner of a spot color (S) is an example of spot-color toner, or toner of a color other than yellow (Y), magenta (M), cyan (C), and black (K). Toner of a spot color (S) is, for example, toner of white (W), a clear color (or a transparent color (CR)), gold, or silver.

The monochrome units 21Y, 21M, 21C, 21K, and 21S have the same structure except for the colors of toner images that they form. Hereafter, when the monochrome units 21Y, 21M, 21C, 21K, and 21S and their components are not to be distinguished one from another, the monochrome units 21Y, 21M, 21C, 21K, and 21S and their components are described while being denoted with reference signs excluding alphabetic characters (Y, M, C, K, and S). Each monochrome unit 21 includes a photoconductor 22, a charging roller 24, an exposure device 26, the developing device 100, and a cleaning device 28.

The photoconductor 22 rotates in a direction indicated with arrow A during image formation. The direction indicated with arrow A is an example of a predetermined direction. The charging roller 24 applies a voltage obtained by superposing an alternating-current voltage on a direct-current voltage to charge the surface of the photoconductor 22 with electricity. The charging roller 24 is disposed downstream from a cleaning blade 28A and upstream from the developing device 100 in a rotation direction of the photoconductor 22.

The cleaning device 28 is disposed downstream from the developing device 100 and downstream from a toner-image transfer position in the rotation direction of the photoconductor 22. The cleaning device 28 has a plate shape, and includes the cleaning blade 28A that is in contact with the surface of the photoconductor 22. The cleaning blade 28A is an example of a cleaner. While the far end of the cleaning blade 28A is directed to face upstream in the rotation direction of the photoconductor 22 indicated with arrow A (that is, faces in the direction opposite to the rotation direction), the cleaning blade 28A is in contact with the surface of the photoconductor 22. The cleaning device 28 further includes a cleaning brush 28B that comes into contact with the surface of the photoconductor 22 at a portion upstream from the cleaning blade 28A. When the photoconductor 22 rotates in the direction indicated by arrow A, the cleaning blade 28A and the cleaning brush 28B remove toner remaining on the surface of the photoconductor 22.

The transfer device 16 has functions of carrying toner images of different colors formed by the monochrome units 21, and transferring the toner images to transported sheets P. The transfer device 16 includes the intermediate transfer belt 30, five transfer rollers 32, a driving roller 38, a second transfer portion 36, a tension roller 34, and a cleaning device 80. The intermediate transfer belt 30 is endless. The five transfer rollers 32 each form a nip with a corresponding one of the photoconductors 22 while holding the intermediate transfer belt 30 therebetween. The intermediate transfer belt 30 is circularly moved by the driving roller 38 in the arrow direction. For example, the monochrome units 21S, 21Y, 21M, 21C, and 21K are arranged in this order from upstream to downstream in the circular movement direction of the intermediate transfer belt 30. Thus, the toner images on the photoconductors 22 formed by the monochrome units 21S, 21Y, 21M, 21C, and 21K are transferred to the intermediate transfer belt 30 by the transfer rollers 32 in a superposed manner.

The second transfer portion 36 includes a transfer roller 54 that is in contact with the surface of the intermediate transfer belt 30 that carries the toner images, and an opposing roller 56 disposed to face the transfer roller 54 while holding the intermediate transfer belt 30 therebetween. At the second transfer portion 36, the toner images of the respective colors carried on the intermediate transfer belt 30 are transferred to a transported sheet P. The cleaning device 80 is disposed downstream from the second transfer portion 36 in the circular movement direction of the intermediate transfer belt 30. The cleaning device 80 includes a cleaning blade 80A that is in contact with the intermediate transfer belt 30, and a cleaning brush 80B that is in contact with the intermediate transfer belt 30 at a portion upstream from the cleaning blade 80A. The cleaning blade 80A and the cleaning brush 80B remove toner remaining on the intermediate transfer belt 30.

The recording medium transporting device 18 has a function of transporting the sheets P while allowing the sheets P to pass through a nip N1 of the second transfer portion 36 and a nip N2 of the fixing device 20. The recording medium transporting device 18 includes multiple transport rollers 44 and a transport belt 46. The transport rollers 44 include pairs of rollers. The transport rollers 44 transport the sheets P held in the recording medium holder 12 along a transport path 18A.

The transport belt 46 includes a pair of rollers spaced apart from each other and an endless belt wound around the pair of rollers. The transport belt 46 is disposed downstream from the second transfer portion 36 and upstream from the fixing device 20 in the transport direction of the sheets P. The transport belt 46 transports each sheet P to which toner images have been transferred at the second transfer portion 36 to a fixing device 50 along the transport path 18A.

The fixing device 20 has a function of fixing, at the nip N2, the toner images transferred (second-transferred) to each sheet P by the transfer device 16. The fixing device 20 includes a heating portion 62 including an endless belt that moves circularly, and a pressing roller 64 that is pressed against the heating portion 62. When each sheet P is transported to the nip N2 between the heating portion 62 and the pressing roller 64, the toner images on the sheet P are fixed by heat and pressure.

The controller 70 has a function of controlling each portion in the image forming system 10. For example, the controller 70 controls the portions in the image forming system 10 (causes the portions to operate accordingly) in accordance with image forming data received from an external device (not illustrated). The image forming data contains image data (image information) that causes each monochrome unit 21 to form a toner image, and other data used to perform the image forming operation.

The image forming system 10 includes a density sensor 72 downstream from the monochrome units 21S, 21Y, 21M, 21C, and 21K in the circular movement direction of the intermediate transfer belt 30. The density sensor 72 detects the density of the toner images transferred to the intermediate transfer belt 30. An example of the density sensor 72 is a reflective optical sensor including a light emitting element and a light receiving element.

### Operation of Image Forming System

Subsequently, the operation of the image forming system 10 is described.

The controller 70 that has received image forming data from an external device (not illustrated) operates the toner image forming portion 14, the transfer device 16, the recording medium transporting device 18, and the fixing device 20. In the toner image forming portion 14, each charging roller 24 charges the corresponding photoconductor 22 with electricity, and the corresponding exposure device 26 exposes the photoconductor 22 to light to form, on the surface of the photoconductor 22, an electrostatic latent image by a difference in charging potential. Each developing device 100 develops the electrostatic latent image on the corresponding photoconductor 22 into a toner image. Thus, a toner image is formed on each photoconductor 22.

Subsequently, a voltage (first transfer voltage) is applied from a power supply (not illustrated) to the transfer rollers 32. The driving roller 38 driven by a driving source (not illustrated) rotates the intermediate transfer belt 30 in the arrow direction. Thus, toner images of the respective colors are first-transferred to the intermediate transfer belt 30 in a superposed manner.

In addition, the recording medium transporting device 18 transports the sheet P to the nip N1 at a time when the toner images of different colors carried on the rotating intermediate transfer belt 30 arrive at the nip N1. At the second transfer portion 36, a voltage (a second transfer voltage) is applied from a power supply (not illustrated) to a power supply roller (not illustrated) that is in contact with the outer circumference of the opposing roller 56, and the toner images of the different colors are thus second-transferred to the sheet P that passes through the nip N1.

Subsequently, the recording medium transporting device 18 transports, to the nip N2, the sheet P to which the toner images of the respective colors are second-transferred, and the fixing device 20 fixes the toner images of the respective colors to the sheet P that passes through the nip N2 to form an image on the sheet P. Thereafter, the sheet P is discharged by the transport rollers 44 to a sheet outlet portion 66.

### Developing Device

Thereafter, the developing device 100 is described.

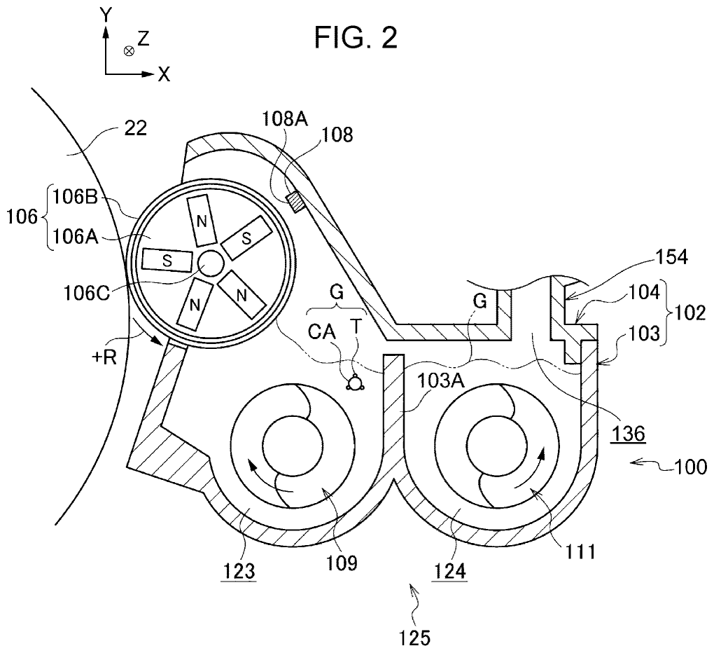

As illustrated in FIG. 2, the developing device 100 is disposed to oppose the photoconductor 22. The developing device 100 includes a housing 102 that accommodates a developer G, a development roller 106 that carries the developer G, a trimmer 108 that regulates the thickness of a layer of the developer G on the outer circumferential surface of the development roller 106, and a developer agitation transport portion 125. For example, the developer agitation transport portion 125 includes a first agitation transport chamber 123, and a second agitation transport chamber 124 adjacent to the first agitation transport chamber 123. The first agitation transport chamber 123 receives a first auger 109, and the second agitation transport chamber 124 receives a second auger 111.

As illustrated in FIG. 2, for example, the developer G is a binary developer containing toner T serving as an example of particles charged with negative-polarity electricity, and carriers CA serving as an example of magnetic particles charged with positive-polarity electricity.

The housing 102 includes a container body 103 and a covering member 104 that closes the upper portion of the container body 103. The container body 103 includes a partitioning wall 103A that partitions the first agitation transport chamber 123 and the second agitation transport chamber 124. The container body 103 has inlet ports (not illustrated) at both end portions of the partitioning wall 103A in the Z-direction to communicate with the first agitation transport chamber 123 and the second agitation transport chamber 124. In the first agitation transport chamber 123 and the second agitation transport chamber 124, the first auger 109 and the second auger 111 rotate in the opposite directions to transport the developer G while agitating the developer G.

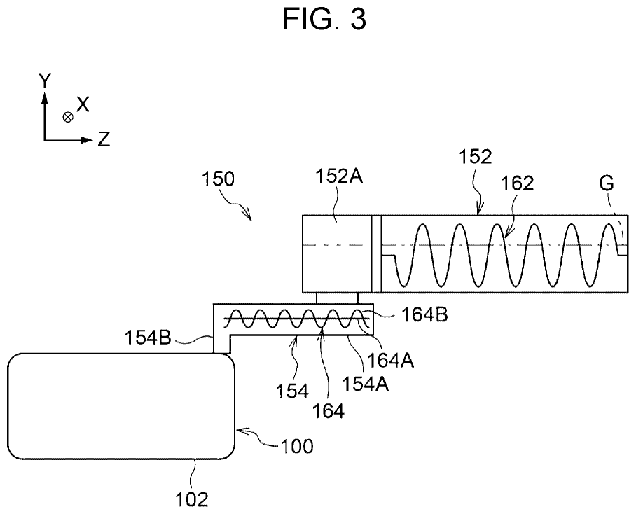

The covering member 104 has a developer replenishment port 136. For example, the developer replenishment port 136 is located above the second agitation transport chamber 124. A lower end portion of a supply path 154 (refer to FIG. 3), described later, for replenishing new toner T is coupled to the developer replenishment port 136.

The development roller 106 includes a magnet roller 106A fixed to and supported on the container body 103 with a shaft 106C, and a cylindrical development sleeve 106B circularly movably supported on the outer side of the magnet roller 106A. The magnet roller 106A has multiple magnetic poles arranged along the outer circumferential surface (in the circumferential direction).

The developer G in the first agitation transport chamber 123 is transported by a rotation of the development sleeve 106B in a +R-direction while being carried on the development sleeve 106B. The developer G carried on the development sleeve 106B has its layer thickness regulated while moving into a space between the outer circumferential surface of the development sleeve 106B and a far end portion 108A of the trimmer 108, and is transported to a development area opposing the photoconductor 22.

### Developer Replenishment Device

Subsequently, the developer replenishment device 150 is described.

As illustrated in FIG. 1, the image forming system 10 includes developer replenishment devices 150Y, 150M, 150C, 150K, and 150S that respectively replenish the developing devices 100 of the monochrome units 21Y, 21M, 21C, 21K, and 21S with the developers G containing toner T of different colors (yellow (Y), magenta (M), cyan (C), black (K), and a spot color (S)). The developer replenishment devices 150Y, 150M, 150C, 150K, and 150S respectively include developer cartridges 152Y, 152M, 152C, 152K, and 152S each holding a developer G containing toner of a different color (yellow (Y), magenta (M), cyan (C), black (K), or a spot color (S)). Each developer G contains toner T of the corresponding color and the carriers CA. The developer cartridges 152Y, 152M, 152C, and 152K that each hold the developer G of normal-color toner T are an example of normal-color developer holders. The developer cartridge 152S that holds the developer G containing spot-color (S) toner T is an example of a spot-color developer holder.

The developer replenishment devices 150Y, 150M, 150C, 150K, and 150S have the same structure other than the color of the toner that they carry or transport. Hereinbelow, when the toner colors of the developer replenishment devices 150Y, 150M, 150C, 150K, and 150S are not to be distinguished one from another, the developer replenishment devices 150Y, 150M, 150C, 150K, and 150S are described while being denoted with reference signs excluding alphabetic characters (Y, M, C, K, and S).

As illustrated in FIG. 3, the developer replenishment device 150 includes the supply path 154 coupled to a lower portion of a developer cartridge 152. The supply path 154 supplies the developer G from the developer cartridge 152 to the developing device 100. The supply path 154 includes a cylindrical crosswise transport path 154A coupled to the developer cartridge 152, and a cylindrical vertical transport path 154B coupled to the end portion of the crosswise transport path 154A opposite to the end portion to which the developer cartridge 152 is coupled.

The developer cartridge 152 is cylindrical and receives an agitator 162 that transports the developer G. The agitator 162 includes, for example, a helical member that rotates.

The crosswise transport path 154A is disposed in the crosswise direction of the image forming system 10, that is, the horizontal direction. The upstream end portion of the crosswise transport path 154A in the transport direction of the developer G is coupled to an end portion 152A of the developer cartridge 152 in the axial direction. The crosswise transport path 154A receives a transport member 164 that transports the developer G in the axial direction of the crosswise transport path 154A.

The transport member 164 includes a rotation shaft 164A disposed in the longitudinal direction (Z-direction) of the crosswise transport path 154A and a helical transport blade 164B supported on the outer circumference of the rotation shaft 164A. The transport member 164 transports, to the vertical transport path 154B, the developer G introduced from the developer cartridge 152 into the crosswise transport path 154A with the rotation of the rotation shaft 164A.

The vertical transport path 154B is disposed in the vertical direction, and a downstream end portion of the vertical transport path 154B in the transport direction of the developer G is connected to the covering member 104 of the developing device 100 (refer to FIG. 2). The vertical transport path 154B allows toner transported from the crosswise transport path 154A to fall to feed the developer G to the developing device 100.

In the developer replenishment device 150, the developer cartridge 152 is attachable to and detachable from the supply path 154. For example, when the developer G in the developer cartridge 152 containing the toner T of a normal color (yellow (Y), magenta (M), cyan (C), or black (K)) or the spot color (S) has little left, the developer cartridge 152 is replaced with a new developer cartridge 152 containing the toner T of the same color. In this case, simply, the old developer cartridge 152 is removed from the crosswise transport path 154A of the supply path 154, and a new developer cartridge 152 containing the toner T of the same color is attached to the crosswise transport path 154A of the supply path 154.

In the first exemplary embodiment, the developer cartridge 152 containing specific-color toner T is replaceable with a developer cartridge 152 containing the toner T of a different color. The case where the developer cartridge 152 containing the specific-color toner T is replaced with the developer cartridge 152 containing the toner T of a different color is described later.

### Control Configuration of Image Forming System

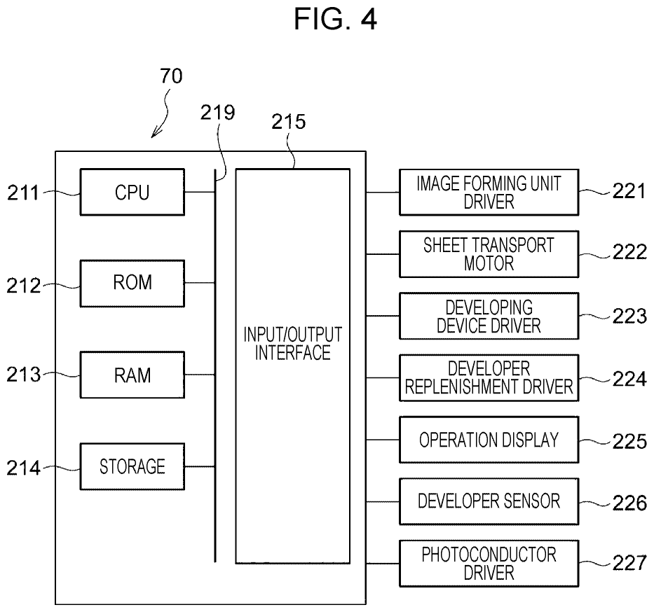

Subsequently, the control configuration or the electrical system configuration of the image forming system 10 is described. FIG. 4 is a block diagram of a hardware configuration of the image forming system 10.

As illustrated in FIG. 4, the controller 70 includes a central processing unit (CPU) 211, a read only memory (ROM) 212, a random-access memory (RAM) 213, a storage 214, and an input/output interface 215. These components are connected to one another with a bus 219 to communicate with one another.

The CPU 211 is a central processing unit, and executes various programs or controls each component. The CPU 211 is an example of a processor. The CPU 211 reads the programs from the ROM 212 or the storage 214, and executes the programs using the RAM 213 as a work area. In the present exemplary embodiment, the processing program is stored in the ROM 212 or the storage 214. The CPU 211 performs controls on each component or various calculations as instructed by the processing program recorded in the ROM 212 or the storage 214.

The ROM 212 stores various programs and various types of data. The RAM 213 temporarily stores the programs or data as a work area. The storage 214 is formed from a hard disk drive (HDD) or a solid state drive (SSD), and stores various types of data and various types of programs including the operating system.

The input/output interface 215 is an interface to transmit or receive information to or from peripheral devices around the controller 70. The input/output interface 215 is connected to an image forming unit driver 221, a sheet transport motor 222, a developing device driver 223, a developer replenishment driver 224, an operation display 225, a developer sensor 226, and a photoconductor driver 227, and transmits or receives information to or from each component. Instead of this structure, the image forming system 10 according to one or more exemplary embodiments of the present disclosure may be directly connected to, with the bus 219, at least one of the image forming unit driver 221, the sheet transport motor 222, the developing device driver 223, the developer replenishment driver 224, the operation display 225, the developer sensor 226, and the photoconductor driver 227.

The image forming unit driver 221 is connected to the monochrome units 21 in the toner image forming portion 14 and the transfer device 16. The image forming unit driver 221 receives an instruction from the CPU 211 in the controller 70, and drives the components in the monochrome units 21 and the transfer device 16.

The sheet transport motor 222 is connected to the transport rollers 44 and the transport belt 46 with a driving mechanism such as gears. In accordance with the driving of the sheet transport motor 222, the transport rollers 44 rotate, and the transport belt 46 circularly moves. The sheet transport motor 222 controls transport of the sheets P at a time when the monochrome units 21 and the transfer device 16 form images.

The developing device driver 223 is connected to each component in the developing devices 100. The developing device driver 223 receives an instruction from the CPU 211, and drives each component in the developing devices 100. For example, the developing device driver 223 controls rotations of the development rollers 106, the first augers 109, and the second augers 111.

The developing device driver 223 drives each developing device 100 based on the operation command from the CPU 211 to form a toner image on the surface of the corresponding photoconductor 22. For example, when forming an image on the image data, the developing device driver 223 drives the developing device 100 of each color in accordance with the image data to form the toner images of the respective colors on the surfaces of the photoconductors 22. When, for example, the developer G in any developing device 100 is changed to the developer G containing the toner T of a different color, the developing device driver 223 drives the developing device 100 to form a toner band as an example of a belt-shaped toner image on the surface of the photoconductor 22. The toner band is described later.

The developer replenishment driver 224 is connected to each component in the developer replenishment device 150. Upon receipt of an instruction from the CPU 211, the developer replenishment driver 224 drives each component in the developer replenishment devices 150. For example, the developer replenishment driver 224 controls the rotation of the agitator 162 in the developer cartridge 152 and the rotation of the transport member 164 in each developer replenishment device 150 to replenish the corresponding developing device 100 with the developer G.

The operation display 225 receives an instruction from the user of the image forming system 10, and informs the user of various items of information on, for example, the operation states of the image forming system 10. For example, the operation display 225 includes a display button that receives operation instructions with the program, a touchscreen display that displays various items of information, and hardware keys such as a numeric keypad or a start button.

The developer sensor 226 detects information on the developer G such as the color of the toner T or the toner density in the developer G in the developing device 100. For example, the developer sensor 226 detects the type of the toner T. For example, the developer sensor 226 detects an exchange of the developer G containing the specific-color toner T in the developing device 100 with the developer G containing the toner T of a different color. The CPU 211 obtains information on the developer G detected by the developer sensor 226. As an example, the storage 214 stores information on the developer G in the developing device 100 or the developer G in the developer cartridge 152. The storage 214 is an example of a storage.

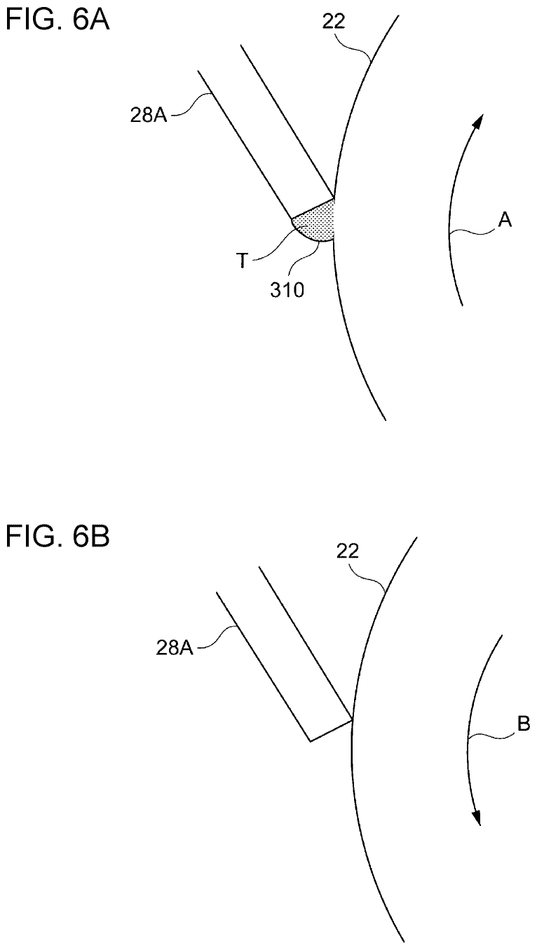

The photoconductor driver 227 controls rotation of the photoconductor 22. When the image forming system 10 forms an image based on the image data, the photoconductor driver 227 rotates the photoconductor 22 in the direction indicated by arrow A based on the operation command from the CPU 211. When the developer G in the developing device 100 is changed to the developer G containing the toner T of a different color, the photoconductor driver 227 rotates, based on the operation command from the CPU 211, the photoconductor 22 located to face the developing device 100 in the direction opposite to the direction indicated by arrow A. More specifically, the photoconductor driver 227 rotates the photoconductor 22 in the direction indicated by arrow B (refer to FIG. 6B).

### Replacement of Developer Cartridge

Now, the replacement of the developer cartridges 152 in the image forming system 10 is described.

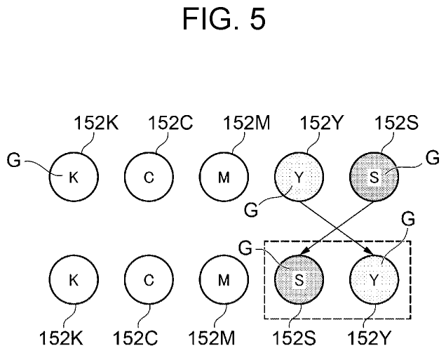

FIG. 5 illustrates an example where a developer cartridge 152Y that holds the developer G containing yellow (Y) toner T and the carriers CA is exchanged with a developer cartridge 152S that holds the developer G containing spot-color (S) toner T and the carriers CA. As illustrated in FIG. 5, the developer cartridge 152Y is replaced with a new developer cartridge 152S at a position (refer to FIG. 1) where the developer cartridge 152Y is located to face the photoconductor 22 and the developing device 100. Similarly, the developer cartridge 152S is replaced with a new developer cartridge 152Y at a position (refer to FIG. 1) where the developer cartridge 152S is located to face the photoconductor 22 and the developing device 100. The spot-color (S) toner T is an example of toner of a color different from yellow (Y). The yellow (Y) toner T is an example of toner of a color different from the spot color (S).

As an example, in the image forming system 10, only the developer cartridge 152Y and the developer cartridge 152S are replaceable (in this example, exchangeable), and the original supply paths 154, the original developing devices 100, and the original photoconductors 22 are not replaced with new ones. More specifically, regardless of when the developer cartridge 152Y and the developer cartridge 152S are exchanged, their supply paths 154, their developing devices 100, and their photoconductors 22 are continuously used without being exchanged with new ones.

In this case, as an example, instead of directly replacing the developer cartridge 152Y with the developer cartridge 152S, a cleaning developer cartridge (not illustrated) that holds a cleaning developer containing the spot-color (S) toner T and the carriers CA may be provided during a replacement from the developer cartridge 152Y to the developer cartridge 152S. For example, the cleaning developer cartridge is attached to the supply path 154, and the cleaning developer causes the developer G containing the yellow (Y) toner T before replacement in the supply path 154 and the developing device 100 to be ejected, to exchange the developer G in the supply path 154 and the developing device 100 with the cleaning developer. Thereafter, the cleaning developer cartridge attached to the supply path 154 may be replaced with the intended developer cartridge 152S.

For example, the developer sensor 226 (refer to FIG. 4) detects an exchange of the developer G containing the yellow (Y) toner T in the developing device 100 with the developer G containing the spot-color (S) toner T. The CPU 211 (refer to FIG. 4) obtains the information on the developer G containing the spot-color (S) toner T detected by the developer sensor 226. As an example, the storage 214 (refer to FIG. 4) stores the information on the developer G containing the spot-color (S) toner T.

Similarly, instead of directly replacing the developer cartridge 152S with the developer cartridge 152Y, a cleaning developer cartridge (not illustrated) that holds the cleaning developer containing the yellow (Y) toner T and the carriers CA may be provided during a replacement from the developer cartridge 152S to the developer cartridge 152Y. For example, the cleaning developer cartridge is attached to the supply path 154, and the cleaning developer causes the developer G containing the spot-color (S) toner T before replacement in the supply path 154 and the developing device 100 to be ejected, to exchange the developer G in the supply path 154 and the developing device 100 with the cleaning developer. Thereafter, the cleaning developer cartridge attached to the supply path 154 may be replaced with the intended developer cartridge 152Y.

For example, the developer sensor 226 (refer to FIG. 4) detects an exchange of the developer G containing the spot-color (S) toner T in the developing device 100 with the developer G containing the yellow (Y) toner T. The CPU 211 (refer to FIG. 4) obtains the information on the developer G containing the yellow (Y) toner T detected by the developer sensor 226. As an example, the storage 214 (refer to FIG. 4) stores the information on the developer G containing the yellow (Y) toner T.

In the image forming system 10, when the developer G in any developing device 100 is changed to the developer G containing the toner T of a different color, the photoconductor 22 located to face the developing device 100 is rotated in the direction opposite to the forward direction indicated with arrow A (refer to FIG. 6A) (a first process). For example, as illustrated in FIG. 6B, by operating the photoconductor driver 227, the CPU 211 rotates the photoconductor 22 in the opposite direction indicated with arrow B.

As illustrated in FIG. 6A, when the photoconductor 22 is rotated in the forward direction (direction indicated by arrow A), the cleaning blade 28A is in contact with the surface of the photoconductor 22. Thus, the toner T accumulates at a contact portion between the far end of the cleaning blade 28A and the photoconductor 22. Thus, a toner pile 310 forms at the contact portion between the far end of the cleaning blade 28A and the photoconductor 22. For example, when the developer cartridge 152Y is replaced with the developer cartridge 152S (refer to FIG. 5), the toner pile 310 forms at the contact portion between the far end of the cleaning blade 28A and the photoconductor 22 at a position corresponding to the developer cartridge 152S. The toner pile 310 may contain the yellow (Y) toner T before the replacement and the spot-color (S) toner T after the replacement. As illustrated in FIG. 6B, the toner pile 310 is flattened by rotating the photoconductor 22 at the position corresponding to the developer cartridge 152S in the opposite direction (the direction indicated by arrow B).

Similarly, when the developer cartridge 152S is replaced with the developer cartridge 152Y (refer to FIG. 5), as illustrated in FIG. 6A, the toner pile 310 forms at the contact portion between the far end of the cleaning blade 28A and the photoconductor 22 at a position corresponding to the developer cartridge 152Y. As illustrated in FIG. 6B, the toner pile 310 is flattened by rotating the photoconductor 22 at the position corresponding to the developer cartridge 152Y in the opposite direction (the direction indicated by arrow B).

For example, the photoconductor 22 is preferably rotated in the opposite direction (the direction indicated by arrow B) by greater than or equal to 2 mm and smaller than or equal to 10 mm with respect to the stop position of the photoconductor 22, or more preferably, by greater than or equal to 3 mm and smaller than or equal to 7 mm. In the first exemplary embodiment, the photoconductor 22 is rotated in the opposite direction (the direction indicated by arrow B) by approximately 4 mm with respect to the stop position.

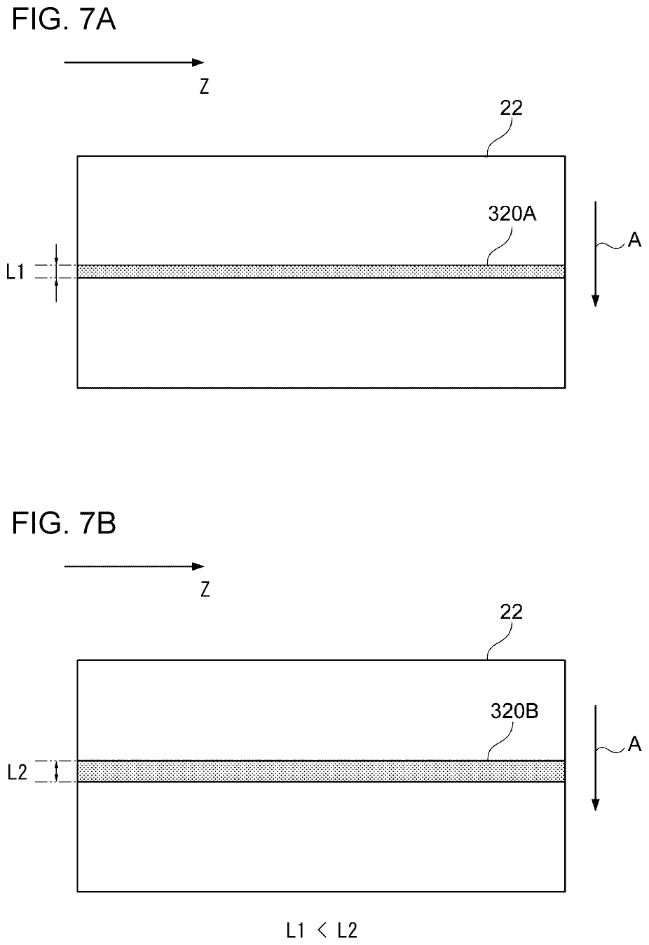

Thereafter, as illustrated in FIG. 7A, at a position corresponding to the developer cartridge 152S containing the spot-color (S) toner T, the developing device 100 forms a toner band 320A on the surface of the photoconductor 22 (a second process) by rotating the photoconductor 22 in the forward direction (direction indicated by arrow A). The toner band 320A is an example of a belt-shaped toner image. For example, the CPU 211 operates components such as the image forming unit driver 221 and the developing device driver 223, and thus the developing device 100 forms the toner band 320A on the surface of the photoconductor 22 (the second process).

Similarly, as illustrated in FIG. 7B, at a position corresponding to the developer cartridge 152Y containing the yellow (Y) toner T, the developing device 100 forms a toner band 320B on the surface of the photoconductor 22 by rotating the photoconductor 22 in the forward direction (the direction indicated by arrow A). The toner band 320B is an example of a belt-shaped toner image.

The toner bands 320A and 320B are formed in a belt shape extending in the axial direction of the photoconductor 22. As an example, the toner bands 320A and 320B may be formed in an area in the longitudinal direction smaller than the full dimension of the photoconductor 22 in the axial direction. The toner bands 320A and 320B are preferably formed in an area in the longitudinal direction corresponding to the full dimension of the development roller 106 in the axial direction, but may be smaller than the full dimension of the development roller 106 in the axial direction. The toner bands 320A and 320B may have different dimensions in the circumferential direction of the photoconductor 22 between the end portions and the middle portion in the longitudinal direction.

The CPU 211 forms either one of the toner bands 320A and 320B on the surface of the photoconductor 22 in accordance with the type of toner T in the developer G obtained after the change. For example, the type of toner T is stored in the storage 214, and the CPU 211 obtains the type of toner from the storage 214.

When the toner T obtained after the change is the spot-color (S) toner T, the toner band 320A is to be formed with a reduced amount of toner compared to the toner band 320B formed with the normal-color toner T. For example, the dimension L1 of the toner band 320A in the circumferential direction of the photoconductor 22 is reduced compared to the dimension L2 for the toner band 320B (specifically, L1<L2) to reduce the amount of toner with which the toner band 320A is formed. At this time, the toner bands 320A and 320B have an equal dimension in the axial direction.

Instead, although not illustrated, the toner band 320B and the toner band 320B may have the same shape, and the toner band 320A may have a reduced toner density compared to the toner band 320B.

The toner band 320A formed on the surface of the photoconductor 22 is removed by the cleaning brush 28B and the cleaning blade 28A (refer to FIG. 1) in the cleaning device 28 with the rotation of the photoconductor 22 in the forward direction (the direction indicated by arrow A). Similarly, the toner band 320B formed on the surface of the photoconductor 22 is removed by the cleaning brush 28B and the cleaning blade 28A (refer to FIG. 1) in the cleaning device 28 with the rotation of the photoconductor 22 in the forward direction (the direction indicated by arrow A).

### Problems of Image Forming System According to Comparative Example

Problems of an image forming system according to a comparative example are described now.

The image forming system according to the comparative example includes a charging roller that charges the surface of the photoconductor with electricity. The charging roller applies a voltage obtained by superposing an alternating-current voltage on a direct-current voltage to charge the surface of the photoconductor with electricity. The image forming system including the charging roller produces more corona products on the surface of the photoconductor than in the case of a scorotron charging system, and is more likely to cause cleaning errors or degradation in image quality. Thus, this image forming system develops the surface of the photoconductor with toner and feeds toner to the cleaning blade to maintain its cleanability. Here, a scorotron is a corona charging device including a grid electrode held between a corona wire and a chargeable body. For example, spot-color toner contains a different base material and different additives from normal-color toner. Thus, when a photoconductor is continuously used after the exchange of the spot-color toner, a cleaning error or degradation in image quality is more likely to occur. Thus, in the image forming system according to the comparative example, at the replacement of the developer cartridges to replace one color with another, the photoconductor of the corresponding color is to be replaced with a new one.

### Operation of First Exemplary Embodiment

Subsequently, the operation of the image forming system 10 according to the first exemplary embodiment is described.

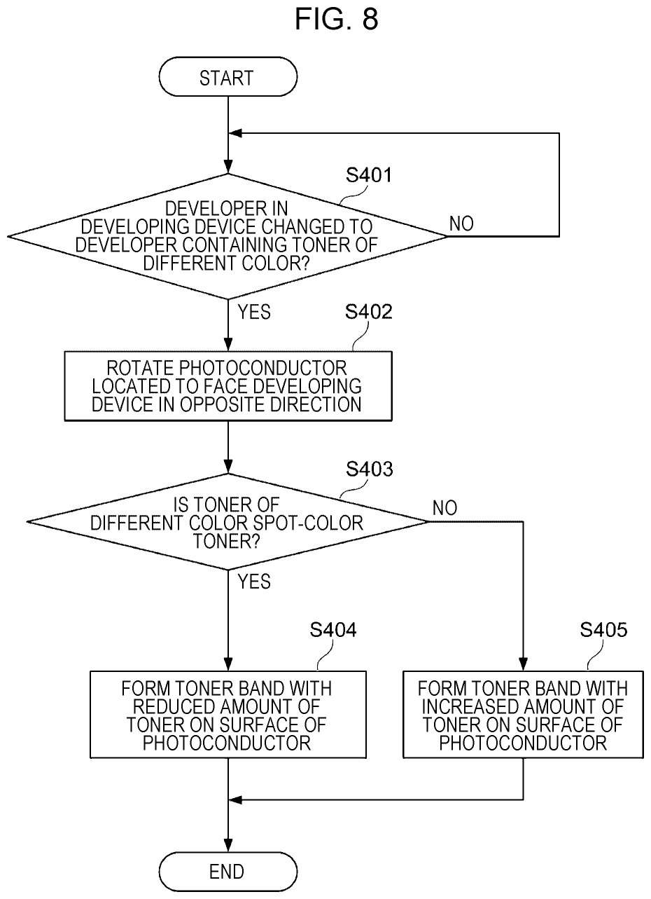

FIG. 8 is a flowchart of the flow of information processing performed by the image forming system 10 according to the first exemplary embodiment. In the image forming system 10, the CPU 211 reads the processing program from the ROM 212 or the storage 214, and deploys and executes the program on the RAM 213 to perform the processing.

The CPU 211 determines whether the developer G in the developing device 100 has been changed to the developer G containing the toner T of a different color (step S401). For example, when the developer sensor 226 detects the developer G containing the toner T of a different color, the CPU 211 determines that the developer G in the developing device 100 has been changed to the developer G containing the toner T of a different color.

When the developer G in the developing device 100 has not been changed to the developer G containing the toner T of a different color (NO in step S401), the CPU 211 waits until the developer G in the developing device 100 is changed to the developer G containing the toner T of a different color.

When the developer G in the developing device 100 has been changed to the developer G containing the toner T of a different color (YES in step S401), the CPU 211 rotates, in the opposite direction, the photoconductor 22 located to face the developing device 100 having the developer G changed to the developer G containing the toner T of a different color (step S402). More specifically, as illustrated in FIG. 6B, the CPU 211 rotates the photoconductor 22 in the direction (the direction indicated by arrow B) opposite to the forward direction (the direction indicated by arrow A).

The CPU 211 determines whether the toner T of a different color is the spot-color (S) toner T (step S403). More specifically, the CPU 211 determines whether the toner T contained in the developer G obtained after the change is spot-color (S) toner T in the developing device 100.

When the toner T of a different color is the spot-color (S) toner T (YES in step S403), the CPU 211 causes the developing device 100 to form the toner band 320A with a reduced amount of toner on the surface of the photoconductor 22 (step S404). For example, as illustrated in FIG. 7A, when the toner T of a different color is the spot-color (S) toner T, the toner band 320A is formed with a reduced amount of toner compared to normal-color toner T with which the toner band 320B is formed. For example, the amount of toner with which the toner band 320A is formed is reduced by reducing the dimension L1 of the toner band 320A in the circumferential direction of the photoconductor 22 compared to the dimension L2 of the toner band 320B.

When the toner T of a different color is not the spot-color (S) toner T (NO in step S403), the CPU 211 causes the developing device 100 to form the toner band 320B with an increased amount of toner on the surface of the photoconductor 22 (step S405). The case where the toner T of a different color is not the spot-color (S) toner T is a case where the toner T of a different color is the normal-color toner T. In this case, as illustrated in FIG. 7B, the toner band 320B is formed with an increased amount of toner compared to the amount of spot-color (S) toner T with which the toner band 320A is formed. For example, the toner band 320B is formed with an increased amount of toner by increasing the dimension L2 of the toner band 320B in the circumferential direction of the photoconductor 22 compared to the dimension L1 of the toner band 320A. Thus, the processing performed by the image forming system 10 based on the processing program ends.

In the image forming system 10, when the developer G in any developing device 100 is changed to the developer G containing the toner T of a different color, the CPU 211 rotates, in the direction opposite to the direction indicated by arrow A, the photoconductor 22 located to face the developing device 100, and then the developing device 100 forms the toner bands 320A and 320B on the surface of the photoconductor 22. For example, as illustrated in FIGS. 6A and 6B, when the photoconductor 22 is rotated in the direction opposite to the direction indicated by arrow A (rotated in the direction indicated by arrow B), the toner pile 310 that forms at the contact portion between the far end of the cleaning blade 28A and the photoconductor 22 is flattened.

Thereafter, as illustrated in FIGS. 7A and 7B, the toner band 320A or 320B is formed by the developing device 100 on the surface of the photoconductor 22, and the toner band 320A or 320B is removed by the cleaning blade 28A and the cleaning brush 28B. Thus, the photoconductor 22 retains the cleanability. The cleanability of the photoconductor 22 indicates cleaning workability and cleaning maintainability of the photoconductor 22 when cleaned by the cleaning blade 28A.

Thus, in the image forming system 10, when the developer G in the developing device 100 is changed to the developer G containing the toner T of a different color, the photoconductor 22 is continuously usable without involving replacement of the photoconductor. Thus, the photoconductor 22 is usable until its lifetime without being replaced with a new one.

In the image forming system 10, the CPU 211 forms either one of the toner bands 320A and 320B on the surface of the photoconductor 22 in accordance with the type of the toner T in the developer G obtained after the change. Thus, the image forming system 10 retains the cleanability of the surface of the photoconductor 22 further than in the case where the same toner bands are formed on the photoconductor with different types of toner.

In the image forming system 10, the storage 214 stores various types of toner T. The CPU 211 obtains the type of toner T from the storage 214. Thus, the image forming system 10 retains the cleanability of the surface of the photoconductor 22 further than in the case where a sensor detects the color of toner.

In the image forming system 10, the case where the developer G in the developing device 100 is changed to the developer G containing the toner T of a different color is a case where the developer G containing normal-color (such as yellow) toner T is changed to the developer containing spot-color (S) toner T (refer to FIG. 5). The case where the developer G in the developing device 100 is changed to the developer G containing the toner T of a different color is a case where the developer G containing the spot-color (S) toner T is changed to the developer G containing the normal-color (such as yellow) toner T (refer to FIG. 5). Thus, in the image forming system 10, the developer G in the developing device 100 is changed from the developer containing normal-color toner T to the developer containing spot-color (S) toner T, and when the developer G containing the spot-color (S) toner T is changed to the developer containing normal-color toner T, the photoconductor 22 is continuously usable without involving replacement.

In the image forming system 10, when the toner T obtained after the change is the spot-color (S) toner T, the toner band 320A is to be formed with a reduced amount of toner compared to the normal-color toner T with which the toner band 320B is formed. For example, the spot-color (S) toner T contains a larger amount of a lubricant than the normal-color toner T. For example, when a toner band is formed with a large amount of toner, the component of the lubricant is more likely to remain on the surface of the photoconductor 22, and is thus more likely to cause insufficient cleaning. To address this, the toner band 320A is to be formed with a reduced amount of spot-color (S) toner compared to the normal-color toner T with which the toner band 320B is formed. Thus, the image forming system 10 retains the cleanability of the surface of the photoconductor 22 further than in the case where the same toner bands are formed with the spot-color toner and from the normal-color toner.

In the image forming system 10, the amount of toner with which the toner band 320A is formed is reduced by reducing the dimension L1 of the toner band 320A in the circumferential direction of the photoconductor 22. Thus, the image forming system 10 easily reduces the amount of toner with which the toner band 320A is formed.

The image forming system 10 includes, downstream from the cleaning blade 28A and upstream from the developing device 100 in the rotation direction of the photoconductor 22, the charging roller 24 that applies a voltage obtained by superposing an alternating-current voltage on a direct-current voltage to charge the surface of the photoconductor 22 with electricity. Thus, the image forming system 10 having a structure in which the charging roller 24 allows corona products to increase on the surface of the photoconductor 22 retains cleanability of the surface of the photoconductor 22.

In the image forming system 10, the developer G is changed by exchanging the developer cartridge 152Y that holds the developer G containing the normal-color (such as yellow) toner T to be fed to the developing device 100 with the developer cartridge 152S that holds the developer G containing the spot-color (S) toner T. Thus, in the image forming system 10, when the developer G in the developing device 100 is changed by exchanging the normal-color (such as yellow) developer cartridge 152Y with the spot-color (S) developer cartridge 152S, the photoconductor 22 is continuously usable without involving replacement.

In the image forming system 10, the CPU 211 rotates the photoconductor 22 located to face the developing device 100 in the opposite direction after a new developer G is fed to the developing device 100 from the normal-color (such as yellow) developer cartridge 152Y, the spot-color (S) toner T contained in the developer G left in the developing device 100 is ejected to the surface of the photoconductor 22, and the surface of the photoconductor 22 is cleaned by, for example, the cleaning blade 28A. In the image forming system 10, after the spot-color (S) toner T contained in the left developer G is removed by the cleaning blade 28A, the photoconductor 22 is rotated in the opposite direction to flatten the toner pile 310 that has accumulated at the contact portion between the cleaning blade 28A and the photoconductor 22.

The CPU 211 rotates the photoconductor 22 located to face the developing device 100 in the opposite direction after the new developer G is fed to the developing device 100 from the spot-color (S) developer cartridge 152S, the normal-color (such as yellow) toner T contained in the developer G left in the developing device 100 is ejected to the surface of the photoconductor 22, and the surface of the photoconductor 22 is cleaned by, for example, the cleaning blade 28A. Thus, in the image forming system 10, the normal-color (such as yellow) toner T contained in the left developer G is removed by the cleaning blade 28A, and the photoconductor 22 is then rotated in the opposite direction to flatten the toner pile 310 that has accumulated at the contact portion between the cleaning blade 28A and the photoconductor 22.

The method for using the photoconductor in the image forming system 10 includes a first process of rotating the photoconductor 22 located to oppose the developing device 100 in the direction opposite to the direction indicated by arrow A when the developer G in the developing device 100 is changed to the developer containing toner T of a different color. The method for using the photoconductor further includes a second process performed after the first process to form the toner band 320A or 320B on the surface of the photoconductor 22 with the developing device 100. Thus, the method for using the photoconductor enables continuous use of the photoconductor 22 without involving replacement of the photoconductor 22 when the developer G in the developing device 100 is changed to the developer G containing the toner T of a different color.

With the method for using the photoconductor, either one of the toner bands 320A and 320B is formed on the surface of the photoconductor 22 in accordance with the type of toner T in the developer G obtained after the change. Thus, the method for using the photoconductor allows the image forming system 10 to retain the cleanability of the surface of the photoconductor 22 further than in the case where the same toner bands are formed on the photoconductor with different types of toner.

The case where the developer G in the developing device 100 is changed to the developer G containing the toner T of a different color is a case where the developer G containing the normal-color (such as yellow) toner T is changed to the developer containing spot-color (S) toner T. Thus, the method for using the photoconductor enables continuous use of the photoconductor 22 without involving replacement of the photoconductor 22 when the developer G in the developing device 100 is changed from the developer G containing the normal-color (such as yellow) toner T to the developer containing spot-color (S) toner T.

The case where the developer G in the developing device 100 is changed to the developer G containing the toner T of a different color is a case where the developer G containing the spot-color (S) toner is changed to the developer G containing the normal-color (such as yellow) toner. Thus, the method for using the photoconductor enables continuous use of the photoconductor 22 without involving replacement of the photoconductor 22 when the developer G in the developing device 100 is changed from the developer G containing the spot-color (S) toner to the developer G containing the normal-color (such as yellow) toner.

When the toner obtained after the change is the spot-color (S) toner, the toner band 320A is to be formed with a reduced amount of toner compared to the normal-color (such as yellow) toner with which the toner band 320B is formed. Thus, the method for using the photoconductor retains the cleanability of the surface of the photoconductor 22 further than in the case where the same toner bands are formed with the spot-color toner and the normal-color toner.

### Second Exemplary Embodiment

Subsequently, an image forming system according to a second exemplary embodiment is described. The same components as those in the first exemplary embodiment are denoted with the same reference signs without being described.

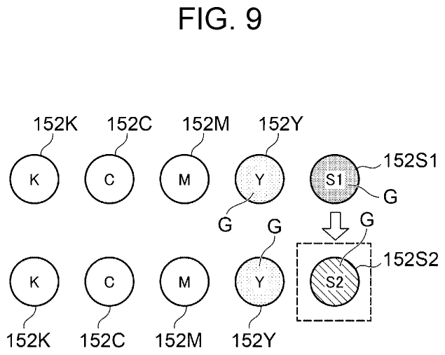

As illustrated in FIG. 9, in the image forming system 10 according to the second exemplary embodiment, a developer cartridge 152S1 that holds the developer G containing toner T of a first spot color (S1) and the carriers CA is replaced with a developer cartridge 152S2 that holds the developer G containing toner T of a second spot color (S2), different from the first spot color (S1), and the carriers CA. The toner of the second spot color (S2) is an example of toner of a different color.

As an example, simply the developer cartridge 152S1 is to be replaced without replacing the supply path 154, the developing device 100, and the photoconductor 22 that have been originally used. More specifically, regardless of when the developer cartridge 152S1 is replaced with the developer cartridge 152S2, the supply path 154, the developing device 100, and the photoconductor 22 are continuously used without being replaced.

In this case, as an example, instead of directly replacing the developer cartridge 152S1 with the developer cartridge 152S2, a cleaning developer cartridge (not illustrated) that holds a cleaning developer containing the toner T of the second spot color (S) and the carriers CA may be provided during a replacement from the developer cartridge 152S1 to the developer cartridge 152S2. For example, the cleaning developer cartridge is attached to the supply path 154, and the cleaning developer causes the developer G containing the toner T of the first spot color (S1) before replacement in the supply path 154 and the developing device 100 to be ejected, to exchange the developer G in the supply path 154 and the developing device 100 with the cleaning developer. Thereafter, the cleaning developer cartridge attached to the supply path 154 may be replaced with the intended developer cartridge 152S2.

Other components are the same as those in the image forming system 10 according to the first exemplary embodiment. More specifically, the CPU 211 rotates the photoconductor 22 located to oppose the developing device 100 in the direction opposite to the direction indicated by arrow A when the developer G in the developing device 100 is changed to the developer G containing the toner T of the second spot color (S2). Thus, after the CPU 211 rotates the photoconductor 22 in the opposite direction, the developing device 100 forms the toner band 320A on the surface of the photoconductor 22.

The image forming system 10 according to the second exemplary embodiment has the following effects in addition to the effects of the components the same as those in the image forming system 10 according to the first exemplary embodiment.

In the image forming system 10 according to the second exemplary embodiment, the case where the developer G in the developing device 100 is changed to the developer G containing the toner T of a different color is a case where the developer G containing toner of the first spot color (S1) is changed to the developer G containing toner of the second spot color (S2). Thus, the image forming system 10 enables continuous use of the photoconductor 22 without involving replacement of the photoconductor 22 when the developer G containing toner of the first spot color (S1) is changed to the developer G containing toner of the second spot color (S2).

In the image forming system 10, the developer G is changed by replacing the developer cartridge 152S1 holding a developer G containing toner of the first spot color (S1) with the developer cartridge 152S2 holding a developer G containing toner of the second spot color (S2). Thus, when the developer G in the developing device 100 is changed by replacing the developer cartridge 152S1 with the developer cartridge 152S2, the image forming system 10 enables continuous use of the photoconductor 22 without involving replacement of the photoconductor 22.

In the image forming system 10, the CPU 211 rotates the photoconductor 22 located to face the developing device 100 in the opposite direction after a new developer G is fed to the developing device 100 from the developer cartridge 152S2, the toner T of the first spot color (S1) contained in the developer G left in the developing device 100 is ejected to the surface of the photoconductor 22, and the surface of the photoconductor 22 is cleaned by the cleaning blade 28A. Thus, in the image forming system 10, after the toner T of the first spot color (S1) contained in the left developer G is removed by the cleaning blade 28A, the photoconductor 22 is rotated in the opposite direction to flatten the toner pile 310 that has accumulated at the contact portion between the cleaning blade 28A and the photoconductor 22.

With the method for using the photoconductor, the case where the developer G in the developing device 100 is changed to the developer G containing the toner T of a different color is a case where the developer containing toner T of the first spot color (S1) is changed to the developer G containing the toner T of the second spot color (S2). The method for using the photoconductor enables continuous use of the photoconductor 22 without involving replacement of the photoconductor 22 when the developer containing the toner T of the first spot color (S1) is changed to the developer G containing the toner T of the second spot color (S2).

### Supplementary Explanation

An information processing system of the present disclosure is not limited to the image forming system 10 according to the first and second exemplary embodiments, and may be changed in various manners. For example, the components in the developing device 100 and the components in the supply path 154 are changeable.

Although the first exemplary embodiment has described the case where the developer cartridge 152Y containing the yellow (Y) toner T is exchanged with the developer cartridge 152S containing the spot-color (S) toner T, the present disclosure is not limited to this example. For example, the developer cartridge 152 containing toner T of a normal color other than yellow (Y) may be exchanged with the developer cartridge 152S containing the spot-color (S) toner T.

The processing performed by the image forming system 10 may instead be performed by a dedicated hardware circuit. In this case, the processing may be performed by a single piece of hardware or multiple pieces of hardware.

The program that operates the image forming system 10 may be provided by a computer-readable recording medium such as a universal serial bus (USB) memory, a flexible disk, or a compact disc read-only memory (CD-ROM), or may be provided online with a network such as the Internet. In this case, the program recorded in the computer-readable recording medium is normally transferred to and stored in, for example, a memory or a storage. This program may be provided as a single piece of application software, or incorporated into software of each device as a function of the image forming system 10.

Although specific exemplary embodiments of the present disclosure are described in detail, it is obvious to those skilled in the art that the present disclosure is not limited to these exemplary embodiments, and various other examples may be embodied within the scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) An image forming system, comprising:
   a plurality of photoconductors that rotate in a predetermined direction, the plurality of photoconductors each having a surface on which an electrostatic latent image is formed by a difference in charging potential;
   a plurality of developing devices that are each disposed to face a corresponding one of the photoconductors, the plurality of developing devices each carrying a developer containing toner of a different color, the plurality of developing devices each developing the electrostatic latent image with the toner to form a toner image;
   a plurality of cleaners that are each disposed downstream from a corresponding one of the developing devices and downstream from a transfer position of the toner image in a rotation direction of a corresponding one of the photoconductors, the plurality of cleaners each having a plate shape, the plurality of cleaners each being in contact with the photoconductor to clean the surface of the photoconductor; and
   at least one processor,
   wherein, the processor is configured to, in a case where the developer in any of the developing devices is changed to a developer containing toner of a different color, rotate the photoconductor located to face the developing device in a direction opposite to the predetermined direction, and to then form a belt-shaped toner image on the surface of the photoconductor with the developing device.
(((2))) The image forming system according to (((1))),
   wherein the processor is configured to vary the belt-shaped toner image formed on the surface of each of the photoconductors in accordance with a type of the toner in the developer obtained after the change.
(((3))) The image forming system according to (((2))), including:
   a storage that stores the type of the toner,
   wherein the processor is configured to obtain the type of the toner from the storage.
(((4))) The image forming system according to any one of (((1))) to (((3))),
   wherein the case where the developer in any of the developing devices is changed to a developer containing toner of a different color is a case where a developer containing toner of any one of normal colors including yellow, magenta, cyan, and black is changed to a developer containing toner of a spot color other than the normal colors, a case where a developer containing toner of the spot color is changed to a developer containing toner of any of the normal colors, or a case where a developer containing toner of the spot color is changed to a developer containing toner of a different spot color.
(((5))) The image forming system according to (((2))),
   wherein, when the toner obtained after the change is toner of a spot color other than the normal colors including yellow, magenta, cyan, and black, the belt-shaped toner image is formed with a reduced amount of toner compared to an amount of the normal color with which the belt-shaped toner image is formed.
(((6))) The image forming system according to (((5))),
   wherein the amount of toner with which the belt-shaped toner image is formed is reduced by reducing a toner density of the belt-shaped toner image, or by reducing a dimension of the belt-shaped toner image in a circumferential direction of the photoconductor.
(((7))) The image forming system according to any one of (((1))) to (((6))), including:
   a charging roller that applies a voltage obtained by superposing an alternating-current voltage on a direct-current voltage to a portion of a corresponding one of the photoconductors downstream from a corresponding one of the cleaners and upstream from a corresponding one of the developing devices in a rotation direction of the photoconductor, to charge the surface of the photoconductor with electricity.
(((8))) The image forming system according to (((4))),
   wherein the developer is changed by exchanging a normal-color developer holder that holds a developer containing toner of the normal color to be fed to the corresponding developing device with a spot-color developer holder that holds a developer containing toner of the spot color, or by replacing a spot-color developer holder that holds a developer containing toner of the spot color with a different spot-color developer holder that holds a developer containing toner of a different spot color.
(((9))) The image forming system according to (((8))),
   wherein the processor is configured to rotate the photoconductor located to face the corresponding developing device in an opposite direction after a new developer is fed to the developing device from the normal-color developer holder, the spot-color developer holder, or the different spot-color developer holder, the toner contained in the developer left in the developing device is ejected to the surface of the photoconductor, and the surface of the photoconductor is cleaned by the cleaner.
(((10))) A method for using a photoconductor in an image forming system, the image forming system including
   a plurality of photoconductors that rotate in a predetermined direction, the plurality of photoconductors each having a surface on which an electrostatic latent image is formed by a difference in charging potential,
   a plurality of developing devices that are each disposed to face a corresponding one of the photoconductors, the plurality of developing devices each carrying a developer containing toner of a different color, the plurality of developing devices each developing the electrostatic latent image with the toner to form a toner image,
   a plurality of cleaners that are each disposed downstream from a corresponding one of the developing devices and downstream from a transfer position of the toner image in a rotation direction of a corresponding one of the photoconductors, the plurality of cleaners each having a plate shape, the plurality of cleaners each being in contact with the photoconductor to clean the surface of the photoconductor,
   the method comprising:
   a first process of rotating, in a case where the developer in any of the developing devices is changed to a developer containing toner of a different color, the photoconductor located to face the developing device in a direction opposite to the predetermined direction, and
   a second process of forming a belt-shaped toner image on the surface of the photoconductor with the developing device, the second process being performed after the first process.
(((11))) The method for using a photoconductor according to (((10))),
   wherein the belt-shaped toner image formed on the surface of the photoconductor is varied in accordance with a type of the toner in the developer obtained after the change.
(((12))) The method for using a photoconductor according to (((10))) or (((11))),
   wherein the case where the developer in any of the developing devices is changed to a developer containing toner of a different color is a case where a developer containing toner of any one of normal colors including yellow, magenta, cyan, and black is changed to a developer containing toner of a spot color other than the normal colors, a case where a developer containing toner of the spot color is changed to a developer containing toner of any of the normal colors, or a case where a developer containing toner of the spot color is changed to a developer containing toner of a different spot color.
(((13)) The method for using a photoconductor according to (((11))),
   wherein, when the toner obtained after the change is toner of a spot color other than the normal colors including yellow, magenta, cyan, and black, the belt-shaped toner image is formed with a reduced amount of toner compared to an amount of the toner of the normal color with which the belt-shaped toner image is formed.

What is claimed is:

1. An image forming system, comprising:
a plurality of photoconductors that rotate in a predetermined direction, the plurality of photoconductors each having a surface on which an electrostatic latent image is formed by a difference in charging potential;
a plurality of developing devices that are each disposed to face a corresponding one of the photoconductors, the plurality of developing devices each carrying a developer containing toner of a different color, the plurality of developing devices each developing the electrostatic latent image with the toner to form a toner image;
a plurality of cleaners that are each disposed downstream from a corresponding one of the developing devices and downstream from a transfer position of the toner image in a rotation direction of a corresponding one of the photoconductors, the plurality of cleaners each having a plate shape, the plurality of cleaners each being in contact with the photoconductor to clean the surface of the photoconductor; and
at least one processor,
wherein, the processor is configured to, in a case where the developer in any of the developing devices is changed to a developer containing toner of a different color, rotate the photoconductor located to face the developing device in a direction opposite to the predetermined direction, and to then form a belt-shaped toner image on the surface of the photoconductor with the developing device.

2. The image forming system according to claim 1,
wherein the processor is configured to vary the belt-shaped toner image formed on the surface of each of the photoconductors in accordance with a type of the toner in the developer obtained after the change.

3. The image forming system according to claim 2, comprising:
a storage that stores the type of the toner,
wherein the processor is configured to obtain the type of the toner from the storage.

4. The image forming system according to claim 1,
wherein the case where the developer in any of the developing devices is changed to a developer containing toner of a different color is a case where a developer containing toner of any one of normal colors including yellow, magenta, cyan, and black is changed to a developer containing toner of a spot color other than the normal colors, a case where a developer containing toner of the spot color is changed to a developer containing toner of any of the normal colors, or a case where a developer containing toner of the spot color is changed to a developer containing toner of a different spot color.

5. The image forming system according to claim 2,
wherein, when the toner obtained after the change is toner of a spot color other than the normal colors including yellow, magenta, cyan, and black, the belt-shaped toner image is formed with a reduced amount of toner compared to an amount of the normal color with which the belt-shaped toner image is formed.

6. The image forming system according to claim 5,
wherein the amount of toner with which the belt-shaped toner image is formed is reduced by reducing a toner density of the belt-shaped toner image, or by reducing a dimension of the belt-shaped toner image in a circumferential direction of the photoconductor.

7. The image forming system according to claim 1, comprising:
a charging roller that applies a voltage obtained by superposing an alternating-current voltage on a direct-current voltage to a portion of a corresponding one of the photoconductors downstream from a corresponding one of the cleaners and upstream from a corresponding one of the developing devices in a rotation direction of the photoconductor, to charge the surface of the photoconductor with electricity.

8. The image forming system according to claim 4,
wherein the developer is changed by exchanging a normal-color developer holder that holds a developer containing toner of the normal color to be fed to the corresponding developing device with a spot-color developer holder that holds a developer containing toner of the spot color, or by replacing a spot-color developer holder that holds a developer containing toner of the spot color with a different spot-color developer holder that holds a developer containing toner of a different spot color.

9. The image forming system according to claim 8,
wherein the processor is configured to rotate the photoconductor located to face the corresponding developing device in an opposite direction after a new developer is fed to the developing device from the normal-color developer holder, the spot-color developer holder, or the different spot-color developer holder, the toner contained in the developer left in the developing device is ejected to the surface of the photoconductor, and the surface of the photoconductor is cleaned by the cleaner.

10. A method for using a photoconductor in an image forming system including:
a plurality of photoconductors that rotate in a predetermined direction, the plurality of photoconductors each having a surface on which an electrostatic latent image is formed by a difference in charging potential,
a plurality of developing devices that are each disposed to face a corresponding one of the photoconductors, the plurality of developing devices each carrying a developer containing toner of a different color, the plurality of developing devices each developing the electrostatic latent image with the toner to form a toner image,
a plurality of cleaners that are each disposed downstream from a corresponding one of the developing devices and downstream from a transfer position of the toner image in a rotation direction of a corresponding one of the photoconductors, the plurality of cleaners each having a plate shape, the plurality of cleaners each being in contact with the photoconductor to clean the surface of the photoconductor,
the method comprising:
a first process of rotating, in a case where the developer in any of the developing devices is changed to a developer containing toner of a different color, the photoconductor located to face the developing device in a direction opposite to the predetermined direction, and
a second process of forming a belt-shaped toner image on the surface of the photoconductor with the developing device, the second process being performed after the first process.

11. The method for using a photoconductor according to claim 10,
wherein the belt-shaped toner image formed on the surface of the photoconductor is varied in accordance with a type of the toner in the developer obtained after the change.

12. The method for using a photoconductor according to claim 10,
wherein the case where the developer in any of the developing devices is changed to a developer containing toner of a different color is a case where a developer containing toner of any one of normal colors including yellow, magenta, cyan, and black is changed to a developer containing toner of a spot color other than the normal colors, a case where a developer containing toner of the spot color is changed to a developer containing toner of any of the normal colors, or a case where a developer containing toner of the spot color is changed to a developer containing toner of a different spot color.

13. The method for using a photoconductor according to claim 11,
wherein, when the toner obtained after the change is toner of a spot color other than the normal colors including yellow, magenta, cyan, and black, the belt-shaped toner image is formed with a reduced amount of toner compared to an amount of the toner of the normal color with which the belt-shaped toner image is formed.
